(19) United States
(12) Patent Application Publication
(10) Pub. No.: US 2009/0029744 A1
(43) Pub. Date: Jan. 29, 2009

(54) ELECTRONIC DEVICE FOR HANDS-FREE OPERATION OF A PORTABLE COMMUNICATION DEVICE

(75) Inventor: Johan Boersma, Emmen (NL)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/828,436

(22) Filed: Jul. 26, 2007

(51) Int. Cl. H04M 1/00

(52) U.S. Cl. 455/569.1

(57) ABSTRACT

A system and method for providing an electronic device that facilitates hands-free operation of a portable communication device in a wide range of applications and environments, including use in a vehicle. The electronic device includes a detector to automatically activate at least a wireless interface based on the occurrence of one or more predetermined events. The generates a signal that directs the control circuit of the electronic device to provide power to a wireless interface to facilitate communication between the electronic device and an associated portable communication device. Once a communication link is established between the electronic device and the portable communication device, the electronic device may function as a car kit, vehicle, speakerphone, etc.

### TECHNICAL FIELD OF THE INVENTION

The present invention relates to a system and method for providing an electronic device that facilitates hands-free operation of a portable communication device in a wide range of applications and environments, including use in a vehicle.

### DESCRIPTION OF THE RELATED ART

Electronic equipment, such as portable communication devices, have evolved from voice-only electronic devices to multi-functional electronic devices. For example, portable communication devices mobile telephones may now function as electronic organizers, digital cameras, audio applications (e.g., MP3 players), video applications (e.g., video players), video game terminals, etc. Moreover, portable communication devices are not only used for voice communications, but they also are used in a variety of other forms (e.g., in instant messaging applications, sharing photographs, gaining access to information on the Internet, etc).

This evolution has caused portable communication devices to be an indispensable social and business companion that may be utilized by a user at any time and any place, including when the user is in a vehicle. In order to make the use of the portable communication device more convenient and easier in a vehicle, a conventional car kit was developed. A conventional car kit is generally an interface between the vehicle (e.g., automobile, truck, sport utility vehicle, van, etc.) and the telephone. The conventional car kit can act as a part of the portable communication device. In conventional use, the portable communication device plugs into the conventional car kit, and uses the structure of the car kit for transmission and reception, e.g., to an external antenna. The conventional car kit generally also has a hands-free kit that allows the user to speak and listen on the portable communications device without using their hands.

There are a variety of problems with conventional car kits installed after market (e.g., after the automobile has been manufactured and/or purchased by a consumer). First, conventional after market car kits generally are not connected to the ignition of the vehicle in which the car kit is installed. Thus, the user is required to manually turn the car kit on and off, as desired. This is undesirable because the user may often forget to switch the car kit to the proper state. Another possibility is to leave the car kit in the on state at all times. One drawback with this approach is draining the battery of the vehicle in which the car kit is installed. Another drawback with conventional after market car kits is that they are generally required to be physically mounted to the car, which may increase the cost of the car kit, as well as require professional installation. In addition, conventional car kits generally include a cradle having a predefined configuration for mating with a particular model of portable communication device and are not suitable for use with other models of portable communication devices. Another drawback with conventional after market car kits is that they are not easily transferable from one vehicle to another.

### SUMMARY

A need exists for an electronic device that can be used to facilitate wireless and/or hands-free communication with one or more portable communication devices in a variety of environments and/or applications. In addition, a need exists for the electronic device to automatically activate at least a wireless interface for communication with the portable communication device based on the occurrence of one or more predetermined events that are detected by the electronic device.

One aspect of the present invention relates to a detector for detecting at least one physical parameter associated with an environment in which the electronic device is located and generating a detection signal when at least one predetermined physical parameter is detected; a wireless interface to facilitate communication between the electronic device and an associated portable communication device; hands-free communication logic including a microphone for receiving communication signals from the associated user and a speaker for outputting communication signals to the associated user; and control circuitry operable to provide power from a power source to at least the wireless interface upon receiving the detection signal.

According to an aspect of the invention, a housing is provided that at least partially encloses each of the detector, the wireless interface, hands-free communication logic and the control circuitry.

According to an aspect of the invention, the power source is at least partially enclosed in the housing.

According to an aspect of the invention, the power source is a removable power source.

According to an aspect of the invention, the power source is a battery.

According to an aspect of the invention, the power source is an external power source.

According to an aspect of the invention, the power source also supplies power to one or more electrical operations of an associated vehicle in which the electronic device is located.

According to an aspect of the invention, the detector is a motion detector.

According to an aspect of the invention, the detector is an accelerometer.

According to an aspect of the invention, the detector is at least one infrared sensor.

According to an aspect of the invention, the wireless interface is Bluetooth-compatible.

According to an aspect of the invention, the device is removable from one environment to another environment without detaching any wires and functional for its intended use without attaching any wires.

Another aspect of the invention relates to a method for hands-free communication between a portable communication device and an electronic device, the method comprising: providing an electronic device, wherein the electronic device includes a housing that at least partially houses a detector for detecting at least one predetermined event; a local wireless interface adapter to facilitate communication between at least one component of the electronic device and an associated portable communication device; a removable power source and hands-free communication logic including a microphone for receiving communication signals from the associated user and a speaker for outputting communication signals to the associated user; determining an occurrence of the at least one predetermined event by the detector; providing power from the removable power source to the local wireless interface adapter; transmitting a request from the electronic device to the associated portable communication device; determining if one or more associated portable communication devices has responded to the inquiry request; establish a communication link between the electronic device and the one or more associated portable communication devices that responded to the request.

According to an aspect of the invention, the communication link established is a piconet formed using a Bluetooth compatible communication protocol.

According to an aspect of the invention, the piconet is maintained until the associated portable communication device is outside a communication range of the electronic device.

According to an aspect of the invention, the associated portable communication device is outside a communication range of the electronic device, the control circuit logically terminates power being supplied from the removable power source to the local wireless interface adapter.

According to an aspect of the invention, the request is a paging request that seeks a unique device name from one or more associated devices within a communication range of the electronic device.

According to an aspect of the invention, the detector is at least one selected from the group consisting of: a motion detector, an accelerometer or at least one infrared detector.

Another aspect of the invention relates to an electronic device comprising: a removable power source; an input port for receiving a power signal from an external power source; a detector coupled to the removable power source and the input port, wherein the detector determines the occurrence of one or more predefined events and generates a detection signal upon occurrence of the one or more predefined events; a wireless interface to facilitate communication between the electronic device and an associated portable communication device; hands-free communication logic including a microphone for receiving communication signals from the associated user and a speaker for outputting communication signals to the associated user; and control circuitry operable to provide power from the removable power source or the input port, based on the presence of the external power source, to at least the wireless interface and the hands-free communication logic upon the detector generating the detection signal.

According to an aspect of the invention, a housing is provided for enclosing the removable power source, the input port, the detector, the wireless interface, the hands-free communication logic and the control circuitry.

Other systems, devices, methods, features, and advantages of the present invention will be or become apparent to one having ordinary skill in the art upon examination of the following drawings and detailed description. It is intended that all such additional systems, methods, features, and advantages be included within this description, be within the scope of the present invention, and be protected by the accompanying claims.

It should be emphasized that the term “comprise/comprising” when used in this specification is taken to specify the presence of stated features, integers, steps or components but does not preclude the presence or addition of one or more other features, integers, steps, components or groups thereof.”

The term “portable communication device”, includes all equipment such as mobile telephones, pagers, communicators, i.e., electronic organizers, personal digital assistants (PDA's), portable communication apparatus, smart phones or the like.

### BRIEF DESCRIPTION OF THE DRAWINGS

The foregoing and other embodiments of the invention are hereinafter discussed with reference to the drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is an exemplary block diagram of a system in accordance with aspects of the present invention.

FIG. 2 is an exemplary block diagram of a mobile telephone in accordance with aspects of the present invention.

FIG. 3 is an exemplary block diagram of an exemplary Bluetooth piconet in accordance with aspects of the present invention.

FIG. 4 is an exemplary schematic diagram of an electronic device in accordance with aspects of the present invention.

FIGS. 5 and 6 are exemplary flow charts in accordance with aspects of the present invention.

### DETAILED DESCRIPTION OF EMBODIMENTS

Aspects of the present invention relate to a system and method for providing an electronic device that facilitates hands-free operation of a portable communication device in a wide range of applications and environments, including use in a vehicle. The electronic device includes a detector to automatically activate at least a wireless interface based on the occurrence of one or more predetermined events.

The invention is described primarily in the context of a portable communication device. However, it will be appreciated that the invention is not intended to relate solely to a portable communication device and can relate to any type of electronic equipment. Other types of electronic equipment that may benefit from aspects of the present invention include playback devices having at least audio playback capability or video playback capability in addition to audio playback capability. Exemplary playback devices include MP3 players, CD players and DVD players.

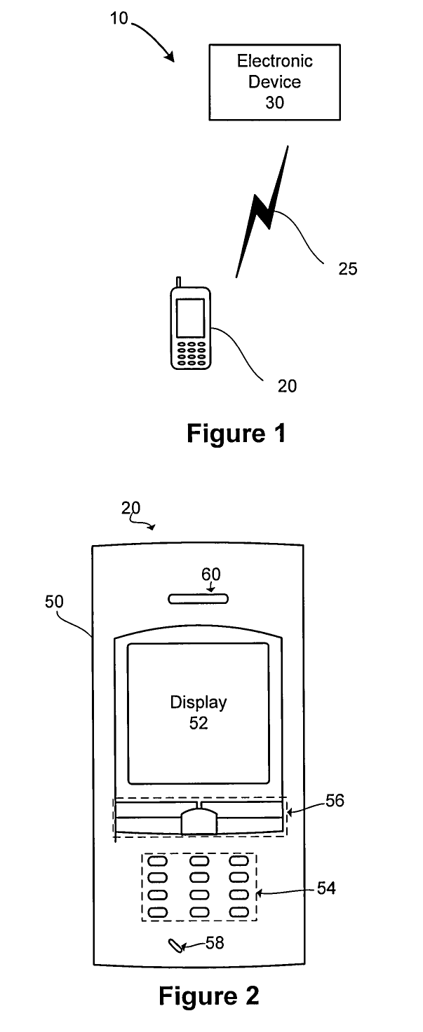

Referring to FIG. 1, an exemplary system 10 in accordance with aspects of the present invention includes a portable communication device 20 and an electronic device 30. The portable communication device 20 may be any type of communication device that includes an interface to a wide area network, such as a mobile telephone network, and optionally may include a local wireless network interface for use in a local area network, such as Bluetooth, for example. Other suitable local wireless network interfaces include, for example, radio frequency, 802.11 compatible protocols, infrared, etc.

The electronic device 30 may be referred to as a car kit and/or vehicle kit because its functionality is readily suited for using a portable communication device in a vehicle. As used herein the term “vehicle” shall be interpreted broadly to include any a means of carrying or transporting something or somebody, including, for example, an automobile, a truck, a sport-utility vehicle, motorcycle, aircraft, watercraft, etc. While aspects of the invention may be described in terms of a car kit and/or a vehicle kit, one of ordinary skill in the art will readily appreciate that aspects of the invention relate to any situation where a user may desire to use his or her portable communication device in a hands-free manner and/or desires to use his or her portable communication as a speakerphone. For example, the electronic device 30 may also be referred to as a speaker phone accessory and/or a hands-free kit.

Referring to FIG. 2, an exemplary portable communication device 20 is illustrated. The portable communication device 20 is shown as having a “brick” or “block” design type housing 50, but it will be appreciated that other type housings such as clamshell or slide-type housings may be utilized without departing from the scope of the invention.

The portable communication device 20 includes a display 52 and keypad 54. As is conventional, the display 52 displays information to a user such as operating state, time, phone numbers, contact information, various navigational menus, etc., which enable the user to utilize the various feature of the portable communication device 20. Similarly, the keypad 54 may be conventional in that it provides for a variety of user input operations. For example, the keypad 54 typically includes alphanumeric keys for allowing entry of alphanumeric information such as telephone numbers, phone lists, contact information, notes, etc. In addition, the keypad 54 typically includes special function keys 56 such as a “call send” key for initiating or answering a call, and a “call end” key for ending, or “hanging up” a call. Special function keys may also include menu navigation keys, for example, for navigating through a menu displayed on the display 52 to select different phone functions, profiles, settings, etc., as is conventional. Other keys included in the keypad 54 may include a volume key, audio mute key, on/off power key, an application launch key (e.g., a web browser launch key, a camera function initiation key, etc.).

The portable communication device 20 also includes a microphone 58 and a speaker 60 that enable a user to listen and speak via the portable communication device 20 and otherwise facilitate communication with others, as is conventional.

The portable communication device 20 includes conventional call circuitry that enables the phone to establish a call with a called/calling device, typically another portable communication device or landline phone. In addition, the portable communication device generally includes a local network interface for use in a local area network.

As shown in FIG. 1, the portable communication device 20 communicates with the electronic device 30 through a wireless communication link 25. One of ordinary skill in the art will readily appreciate that the electronic device may also include a port for communication with the portable communication devices that do not have or otherwise support a wireless local network communication protocol. A suitable communication protocol for the communication link 25 is Bluetooth and/or a Bluetooth-compatible protocol. While the present invention is not limited to use with Bluetooth, the techniques of Bluetooth are often highly advantageous.

In general, the Bluetooth specification is a standard intended for relatively short range, e.g., 10-100 meter, wireless communication. Bluetooth can operate at a number of different power levels, including a 0 dBm level transmit power (e.g., 1 milliwatt) in which the communication has a 10-meter range, and a 20 dBm transmit power (e.g., 100 milliwatts), which has a 100-meter range. Bluetooth operates at around 2.4 GHz, and is capable of transmitting data at about 3 Mbit/sec. Bluetooth is a multiple access system, which uses a frequency-hopped spread spectrum with time division duplex. The frequency hopping occurs at about 1600 hops/sec. Each Bluetooth device has a unique 48-bit address.

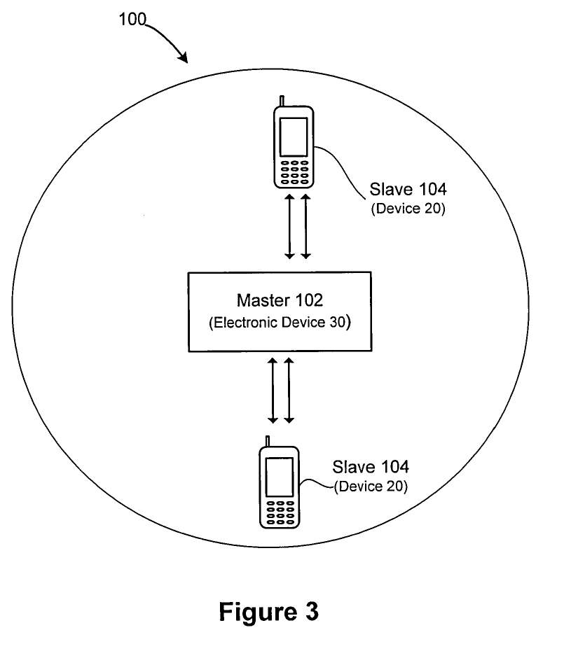

An exemplary Bluetooth piconet 100 is shown in FIG. 3. The piconet 100 is established between a master 102 (e.g., electronic device 20) and one or more slaves 104 (e.g. portable communication devices 30) within an effective communication range (identified by the circle). As one of ordinary skill in the art will readily appreciate, the effective communication range will vary depending on the wireless medium (e.g., radio frequency, infrared, optical, etc.) as well as the communication protocol.

The device that initiates the communication is generally called the master. The master 102 can communicate with one, or more than one, slave units 104. The piconet 100 shown in FIG. 3 is illustrated as communicating with a plurality of different slave units 104. The master unit 102 generally controls the traffic and provides a time reference for the slave units 104. In general operation, each of the slave units 104 share the same frequency-hopping sequence defined by the master 102. In addition, one Bluetooth device can become a member of several piconets.

As described above, each Bluetooth unit is uniquely identifiable based on its 48-bit address. Each Bluetooth unit can also include a Bluetooth device name, which is a user-friendly text string, having a maximum of 240 bytes. A Bluetooth passkey can be included, that forms a personal identification number, which can function to restrict access.

Bluetooth's multiple access scheme operates based on the master sending a request and waiting for a response. The send respond scheme is based on the master's clock. All units in the piconet synchronize with the master's clock.

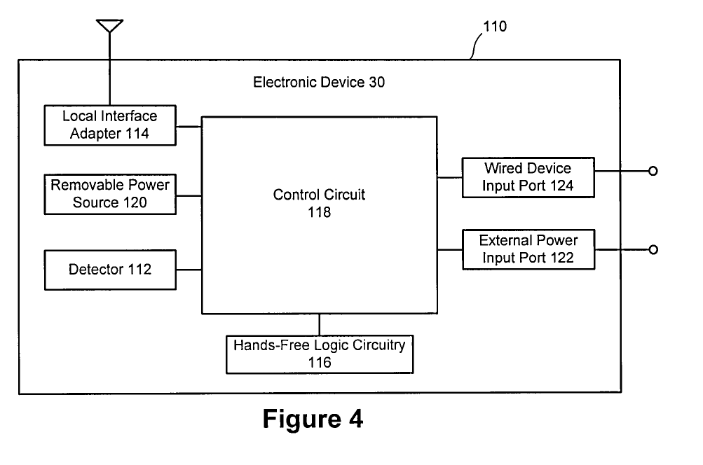

An exemplary electronic device 30 in accordance with aspects of the present invention is illustrated in FIG. 4. The electronic device 30 generally includes a housing 110 that at least partially encloses: a detector 112, a local wireless interface adapter 114, hands-free logic circuitry 116, a control circuit 118 and optionally a removable power source 120 and/or a power input port 122, and an optional device input port 124.

The electronic device 30 may be used to establish wireless and/or hands-free communication with one or more portable communication devices 20 without requiring a hard wire connection of the electronic device 30. In addition, the electronic device 30 may use the removable power source 120 for primary power and/or may rely on an external power source (e.g., a vehicle's battery, a battery, a capacitor, a wall outlet, etc.) depending on the availability of the external power source and/or the application in which the device 30 is being used. For example, if an external power source is available it is generally recommended to use the external power source to conserve power associated with the usually limited supply of power from the removable power source.

The electronic device 30 is provided with a detector 112 to automatically detect a predetermined event and activate logic in the control circuitry to provide power from the removable power source 120 to at least the local wireless interface adapter 114. This operation provides for conservation of power of the removable power source 120. That is, power from the removable source 120 may be provided to only a portion of the components of the electronic device 30. Alternatively, none of the components of the electronic device may be supplied, which effectively enables a longer standby time.

As shown in FIG. 4, the detector 112 may be electrically coupled to at least the control circuit 118. Alternatively or additionally, the detector 112 may also be coupled to the removable power supply 120. The detector 112 may also be coupled to the power input port 122.

The detector 112 may be any suitable detector. A suitable detector is generally a detector that is capable of sensing one or more physical characteristics of an environment or event in which the electronic device 30 is located. For example, the detector 112 may be a movement detector that detects when the electronic device 30 is moving. The detector 112 may be an accelerometer that detects if the electronic device 30 is in the process of accelerating. In addition, the detector 112 may also be one or more infrared sensors that detect heat and/or movement.

Such sensors are particularly well suited for use of the electronic device 30 in a vehicle. For use in a vehicle, any motion, acceleration and/or detected presence of an individual (through the infrared sensors) may correspond to a predetermined event that triggers generation a detection signal to the control circuit 118. One of ordinary skill in the art will readily appreciate that other types of detectors may be used depending on the applicable application. Other exemplary detectors include, light sensors, thermal sensors, etc.

The local wireless interface adapter 114 is coupled to the control circuit 118 and optionally to the removable power supply 120. The local interface adapter 114 is a local wireless interface that supports one or more communication protocols (e.g., Bluetooth-compatible protocols, 802.11-compatible protocols, etc.).

The hands-free circuitry 116 includes circuitry for exchanging digitized voice signals and a speaker for outputting received digitized voice signals. By way of example, in one embodiment, a user driving a vehicle may make or accept a phone call with a friend on the user's Bluetooth-enabled portable communication device. The user speaks into the microphone associated with the hands-free circuitry 116 and the user's voice is digitized and transmitted from the electronic device 30 through the wireless communication link 25 and passes them wirelessly, and substantially according to the Bluetooth specification, to the user's Bluetooth-enabled portable communication device, which transmits the digitized voice signals to the user's friend via the wireless and possibly other networks to the friend's telephone. The friend vocally responds to the user and the friend's voice is transmitted to the user's Bluetooth-enabled portable communication device. The portable communication device passes the caller's digitized voice signals through the local interface adapter 114, which passes the digitized voice signals to the hands-free circuitry 116. The hands-free circuitry 116 outputs the caller's vocal response on a speaker that makes up a portion of the hands-free circuitry 116 and/or the speaker is coupled to the hands-free circuitry 116.

The control circuit 118 is configured to carry out overall control of the functions and operations of the electronic device 30. The control circuit 118 may include a processing device, such as a CPU, microcontroller or microprocessor. The processing device executes code stored in a memory (not shown) within the control circuit 118 and/or in a separate memory (not shown), in order to carry out operation of the electronic device, as described herein. The memory may be, for example, a buffer, a flash memory, a hard drive, a removable media, a volatile memory and/or a non-volatile memory.

As shown in FIG. 4, the control circuit 118 may include a direct communication link to the primary components of the electronic device 30. Although not shown, the various components may also or lieu of a direct communication from the control circuitry 118, include one or more connections between the various components.

The electronic device 30 includes also may include a removable power source 120. The removable power source 120 may be a battery, an alkaline battery, a rechargeable battery or the like. In order to make the electronic device truly portable, preferably the removable power source 120 is enclosed within the housing 110. Generally, conservation of battery power is a primary design criteria in designing a finite powered device. Accordingly, the removable power source 120 is selectably configured to provide power to components of the electronic device 30 on as needed basis. For example, when the detector 112 has not detected a predefined event that generates a detected signal, preferably the removable power source provides power to only a limited number of components. For example, if a predefined event has not occurred there is no need to provide power to the local interface adapter 114.

The electronic device 30 may also include a power input port 122. The power input port may be provided to provide an external power source to the electronic device 30. For example, the power input port 122 may receive an electrical adapter to connect the device 30 to a vehicle battery (e.g., through a cigarette lighter port) or a conventional wall electrical outlet to operate the electronic device 30 and/or charge the removable power source 120.

The electronic device 30 may also include a device input port 122. The device input port 122 may be provided to allow the electronic device 30 to be used with a portable communication device that does not include a local wireless network adapter. In such cases, the electronic device 30 may be coupled to device input port 122 through one or more wires coupled to the microphone and/or speaker port of the portable communication device.

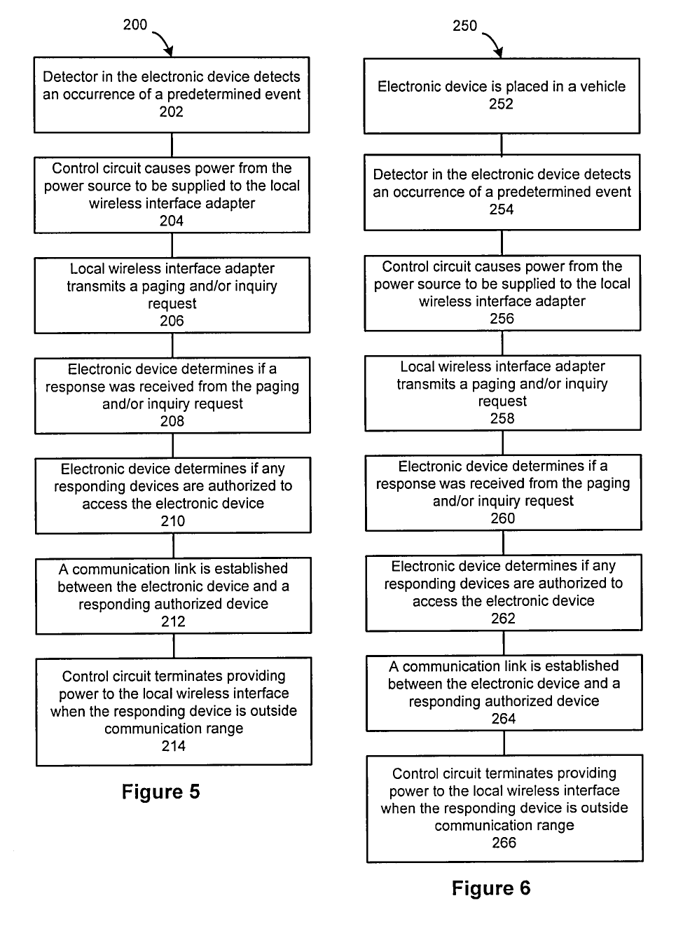

An exemplary method 200 in accordance with aspects of the present invention is illustrated in FIG. 5. The method 200 assumes that the electronic device 30 has been placed in a desired environment. The desired environment may be any environment that the user desires to utilize wireless, hands-free and/or speakerphone functionality of the portable communication device 20 through the electronic device 30.

Once the electronic device 30 is place in the desired location, at block 202, the electronic providing a portable vehicle kit, the detector detects (also referred to herein as “determines”) an occurrence of at least one predetermined event. One of ordinary skill in the art will readily appreciate that the predetermined event is based generally on the type of detector used. For example, a predetermined event may be detecting movement of the electronic device if the detector is motion detector. Another predetermined event may be detecting an acceleration of the electronic device 30, if the detector is an accelerometer. Another predetermined may be detecting presence of an individual, if the detector is an infrared sensor.

Once a predetermined event is detected, at block 204, the control circuit 118 causes power from the power source 120 of the electronic device 30 to provide power to the local wireless interface adapter 114. The local wireless interface adapter 114 then transmits an inquiry and/or paging request from the electronic device to the associated portable communication device, at block 206. The request is generally transmitted through the wireless link 25 between the local wireless interfaces of the electronic device 30 and the portable communication device 20. In one embodiment, the paging and/or inquiry request seeks a unique device address (e.g., unique 48-bit device address) from one or more associated devices within a communication range of the electronic device. In another embodiment, the inquiry request seeks all devices within communication range of the electronic device 20.

At block 208, the electronic device 30 determines if one or more associated portable communication devices 20 has responded to the paging and/or inquiry request.

Optionally, at block 210, the electronic device 30 determines if any of the responding portable communication devices are authorized to access the electronic device 30. One of ordinary skill will appreciate that the step of authorization may take a variety of forms including, for example, receiving device names and comparing the received names to a list of authorized device names to allow access to the electronic device 30.

At block 212, assuming at least one of the responding devices is authorized to access the electronic device 30, a communication link is established between the electronic device 30 and the one or more associated portable communication devices 30 that responded to the inquiry request. The communication link established is preferably a piconet formed using a Bluetooth compatible communication protocol. The piconet is maintained until the associated portable communication device 20 is outside a communication range with the electronic device 30.

At block 214, once the portable communication device 20 is outside the communication range of the electronic device 30, the control circuit 118 terminates providing power to the local wireless interface 114, which conserves power for the power source 120.

Another exemplary method 250 is illustrated in FIG. 6. At block 252, the electronic device 30 is placed in a vehicle. A driver with a portable communication device having a local wireless interface adapter enters the vehicle. At block 254, a predefined event is detected. For example, the predefined event may be the presence of the driver, as detected from an infrared sensor as the detector 112 or the predefined event may be a detected motion and/or acceleration of the vehicle once the driver begins driving the automobile.

Once a predetermined event is detected, at block 256, the control circuit 118 causes power from the power source 120 of the electronic device 30 to provide power to the local wireless interface adapter 114. The local wireless interface adapter 114 then transmits a paging and/or an inquiry request from the electronic device to the associated portable communication device, at block 258. The request is generally transmitted through the wireless link 25 between the local wireless interfaces of the electronic device 30 and the portable communication device 20. In one embodiment, the paging and/or inquiry request seeks a unique device address (e.g., unique 48-bit device address) from one or more associated devices within a communication range of the electronic device. In another embodiment, the inquiry request seeks all devices within communication range of the electronic device 20.

At block 260, the electronic device 30 determines if one or more associated portable communication devices 20 has responded to the inquiry request.

Optionally, at block 262, the electronic device 30 determines if any of the responding portable communication devices are authorized to access the electronic device 30. One of ordinary skill will appreciate that the step of authorization may take a variety of forms including, for example, receiving device names and comparing the received names to a list of authorized device names to allow access to the electronic device 30.

At block 264, assuming at least one of the responding devices is authorized to access the electronic device 30, a communication link is established between the electronic device 30 and the one or more associated portable communication devices 30 that responded to the inquiry request. The communication link established is preferably a piconet formed using a Bluetooth compatible communication protocol. The piconet is maintained until the associated portable communication device 20 is outside a communication range with the electronic device 30.

At step 266, once the portable communication device 20 is outside the communication range of the electronic device 30, the control circuit 118 terminates providing power to the local wireless interface 114, which conserves power for the power source 120.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. It should also be noted that although the specification lists method steps occurring in a particular order, these steps may be executed in any order, or at the same time.

What is claimed is:

1. An electronic device comprising:
a detector for detecting at least one physical parameter associated with an environment in which the electronic device is located and generating a detection signal when at least one predetermined physical parameter is detected;
a wireless interface to facilitate communication between the electronic device and an associated portable communication device;
bands-free communication logic including a microphone for receiving communication signals from the associated user and a speaker for outputting communication signals to the associated user; and
control circuitry operable to provide power from a power source to at least the wireless interface upon receiving the detection signal.

2. The electronic device of claim 1 further including a housing at least partially enclosing each of the detector, the wireless interface, hands-free communication logic and the control circuitry.

3. The electronic device of claim 2, wherein the power source is at least partially enclosed in the housing.

4. The electronic device of claim 3, wherein the power source is a removable power source.

5. The electronic device of claim 4, wherein the power source is a battery.

6. The electronic device of claim 1, wherein the power source is an external power source.

7. The electronic device of claim 6, wherein the power source also supplies power to one or more electrical operations of an associated vehicle in which the electronic device is located.

8. The electronic device of claim 1, wherein the detector is a motion detector.

9. The electronic device of claim 1, wherein the detector is an accelerometer.

10. The electronic device of claim 1, wherein the detector is at least one infrared sensor.

11. The electronic device of claim 1, wherein the wireless interface is Bluetooth-compatible.

12. The electronic device of claim 1, wherein the device is removable from one environment to another without detaching any wires and functional for its intended use without attaching any wires.

13. A method for hands-free communication between a portable communication device and an electronic device, the method comprising:
providing an electronic device, wherein the electronic device includes a housing that at least partially houses a detector for detecting at least one predetermined event; a local wireless interface adapter to facilitate communication between at least one component of the electronic device and an associated portable communication device; a removable power source and hands-free communication logic including a microphone for receiving communication signals from the associated user and a speaker for outputting communication signals to the associated user;
determining an occurrence of the at least one predetermined event by the detector;
providing power from the removable power source to the local wireless interface adapter;
transmitting a request from the electronic device to the associated portable communication device;
determining if one or more associated portable communication devices has responded to the request;
establish a communication link between the electronic device and the one or more associated portable communication devices that responded to the request.

14. The method of claim 13, wherein the communication link established is a piconet formed using a Bluetooth compatible communication protocol.

15. The method of claim 13, wherein the piconet is maintained until the associated portable communication device is outside a communication range of the electronic device.

16. The method of claim 13, wherein when the associated portable communication device is outside a communication range of the electronic device, the control circuit logically terminates power being supplied from the removable power source to the local wireless interface adapter.

17. The method of claim 13, wherein the request is a paging request that seeks a predetermined unique device address from one or more associated devices within a communication range of the electronic device.

18. The method of claim 13, wherein the detector is at least one selected from the group consisting of: a motion detector, an accelerometer or at least one infrared detector.

19. An electronic device comprising:
a removable power source;
an input port for receiving a power signal from an external power source;
a detector coupled to the removable power source and the input port, wherein the detector determines the occurrence of one or more predefined events and generates a detection signal upon occurrence of the one or more predefined events;
a wireless interface to facilitate communication between the electronic device and an associated portable communication device;
hands-free communication logic including a microphone for receiving communication signals from the associated user and a speaker for outputting communication signals to the associated user; and
control circuitry operable to provide power from the removable power source or the input port, based on the presence of the external power source, to at least the wireless interface and the hands-free communication logic upon the detector generating the detection signal.

20. The electronic device of claim 18 further including a housing for enclosing the removable power source, the input port, the detector, the wireless interface, the hands-free communication logic and the control circuitry.
